(19) United States
(12) Patent Application Publication
(10) Pub. No.: US 2024/0219541 A1
(43) Pub. Date: Jul. 4, 2024

(54) SELF-ALIGNED TRANSCEIVER CHIP FOR COHERENT MECHANICAL LIDAR

(71) Applicant: Luminar Technologies, Inc.,, Orlando, FL (US)

(72) Inventors: Daniel Joseph KLEMME, Robbinsdale, MN (US); Daniel Aaron MOHR, St. Paul, MN (US)

(21) Appl. No.: 18/396,594

(22) Filed: Dec. 26, 2023

Related U.S. Application Data
(60) Provisional application No. 63/477,769, filed on Dec. 29, 2022.

(51) Int. Cl. G01S 7/497; G01S 7/481

(52) U.S. Cl. CPC G01S 7/4972; G01S 7/4817; G01S 7/4818

(57) ABSTRACT

A LiDAR system includes a light source to generate light pulses, a lens, a rotating scanning mirror, and a photonic integrated circuit (PIC) chip mechanically registered with the lens. The PIC chip includes a transmission waveguide, a receiver waveguide, and first and second free space couplers lithographically fabricated thereon. A detector is further fabricated on the PIC chip. The transmission waveguide is optically coupled to the light source. The first free space coupler is optically coupled to the transmission waveguide. A second free space coupler is lithographically aligned with the first free space coupler and optically coupled to the receiver waveguide. The detector is optically coupled to a second end of the receiver waveguide. The lens focuses light pulses output from the first free space coupler onto the scanning mirror and returning light reflected from the scanning mirror onto the second free space coupler.

### CROSS-REFERENCE TO RELATED APPLICATIONS

This application is a non-provisional application based on and takes priority from pending U.S. provisional application Ser. No. 63/477,769, entitled “Self-aligned transceiver chip for coherent mechanical LiDAR,” which was filed on Dec. 29, 2022. The disclosure set forth in the referenced application is incorporated herein by reference in its entirety.

### BACKGROUND

Light detection and ranging (LiDAR) is a technology that measures a distance to an object by projecting a laser toward the object and receiving the reflected laser light. The distance is generally calculated from the time of flight (ToF) of the laser light, i.e., the time between generation of the laser light at the LiDAR device and the time a reflection of the laser light is received at a detector at the LiDAR device. The speed of light is a known value and the return trip time is easily converted into distance. Multiple light pulses transmitted at different angles, or a dispersed light transmission, can be used to increase accuracy by triangulation calculations based upon light received at different angles at the detector. Scanning LiDAR provides a more accurate representation of a wide field of view (FoV) by moving the laser light beam, or pulses of laser light, rapidly back and forth and up and down over an area, similar to the movement of an electron beam on the cathode-ray tube of original generation television. Unlike television, however, LiDAR systems operate by detecting the reflected light to discern objects in the field of view. Thus, precise capture of the returning light from the LiDAR laser is important to creating an accurate image of objects in the field of view as well as determining their distance from the LiDAR device.

The information included in this Background section of the specification, including any references cited herein and any description or discussion thereof, is included for technical reference purposes only and is not to be regarded subject matter by which the scope of the invention as defined in the claims is to be bound.

### SUMMARY

The technology disclosed herein relates to a system and corresponding method for aligning a LiDAR transmitter with a corresponding reflected light detector to improve range detection in a mechanical LiDAR system. A corresponding a photonic integrated circuit (PIC) chip designed to provide the desired alignment improvement is also disclosed. Using a lithographic process and exploiting the scanner-induced angle offset to make this system robust. The PIC chip is multifunctional: it routes laser light from a light source into local oscillator and transmit components. This same PIC chip also modulates the laser light before transmission (e.g., using phase modulation or frequency modulation) in such a way as to better recover range when the light is received as reflected by a target. The returning light may be reflected off the faces of a rotating horizontal scan mirror and routed to and from an amplifier before arriving at a free-space coupler on the chip. The PIC chip is designed with consideration of the speed and face area of the horizontal scan mirror that reflects both source and returning light. Sub-micron alignment between source light and returning light received at a plurality of detectors built on the PIC chip is achieved through the fine resolution of the photolithographic process used to form the features on the PIC chip.

In one example implementation, a LiDAR system includes a light source configured to generate light pulses, a lens, a rotating scanning mirror, and a photonic integrated circuit (PIC) chip mechanically registered with the lens. The PIC chip further includes a transmission waveguide lithographically fabricated thereon, wherein a first end of the transmission waveguide is optically coupled to the light source. A first free space coupler is lithographically fabricated on the PIC chip and is positioned at a second end of and optically coupled to the transmission waveguide. A receiver waveguide is lithographically fabricated on the PIC chip. A second free space coupler is lithographically fabricated on the PIC chip and positioned at a first end of and optically coupled to the receiver waveguide. The second free space coupler is further lithographically aligned with the first free space coupler. A detector is fabricated on the PIC chip and optically coupled to a second end of the receiver waveguide. The lens focuses both light pulses generated at the light source and output from the first free space coupler onto the scanning mirror and returning light reflected from the scanning mirror onto the second free space coupler.

In another example implementation, a method of aligning a transmitter with one or more receivers in a LiDAR system is disclosed. The method includes the following steps: lithographically fabricating a transmission waveguide on a photonic integrated circuit (PIC) chip; lithographically fabricating a first free space coupler on the PIC chip at a first end of and optically coupled to the transmission waveguide; optically coupling a light source that generates light pulses to a second end of the transmission waveguide; lithographically fabricating a receiver waveguide on the PIC chip; lithographically fabricating a second free space coupler on the PIC chip at a first end of and optically coupled to the receiver waveguide; lithographically aligning the second free space coupler with the first free space coupler; fabricating a detector on the PIC chip; optically coupling a second end of the receiver waveguide to the detector; and mechanically registering the PIC chip with a lens in the LiDAR system such that the lens focuses both light pulses generated at the light source and output from the first free space coupler onto a rotating scanning mirror and returning light reflected from the scanning mirror onto the second free space coupler.

In a further example implementation, a method of operating a LiDAR system includes the following steps: rotating a scanning mirror; outputting light pulses from a light source; transmitting the light pulses through a transmission waveguide lithographically fabricated on a photonic integrated circuit (PIC) chip; transmitting the light pulse through a first free space coupler lithographically fabricated on the PIC chip at a distal end of and optically coupled to the transmission waveguide through a lens mechanically registered with the first free space coupler to the scanning mirror; reflecting the light pulse off of the scanning mirror toward a target at a distance from the LiDAR system; receiving returning light from the target at the LiDAR system; reflecting the returning light from the scanning mirror through the lens to a second free space coupler lithographically fabricated on the PIC chip and lithographically aligned with the first free space coupler, wherein the lens is further mechanically registered with the second free space coupler; transmitting the returning light through a receiver waveguide lithographically fabricated on the PIC chip, wherein a distal end of the receiver waveguide is optically coupled to the second free space coupler; and receiving the returning light at a detector fabricated on the PIC chip and optically coupled to a proximal end of the receiver waveguide.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example schematic of a mechanical scanning LiDAR system.

FIG. 2 illustrates an alternate view of some of the components of the mechanical scanning LiDAR system of FIG. 1.

FIG. 3 illustrates an effect of a mechanical scanning LiDAR system on reflected light received at the LIDAR system different times of flight delay due to differing distances traveled.

FIG. 4 illustrates an example design of a PIC chip and corresponding transmission and receiving components in a mechanical scanning LiDAR system.

FIG. 5 illustrates a flow diagram of an example method for aligning a transmitter with one or more receivers in a LiDAR system.

FIG. 6 illustrates a flow diagram of an example method for operating a LiDAR system.

FIG. 7 illustrates an example computer processing system that may be useful in implementing the described LiDAR technology.

### DETAILED DESCRIPTION

With any LiDAR system it is important to create an accurate image of objects in the field of view as well as to determine their distance from the LiDAR device. The technology disclosed herein relates to increasing precision in the capture of the returning light from a LiDAR light source and, thereby, achieving more accurate ranging and greater image definition. One or more implementations disclosed herein are described in the context of a scanning LiDAR system. However, the implementations disclosed may be generalized to other LiDAR implementations.

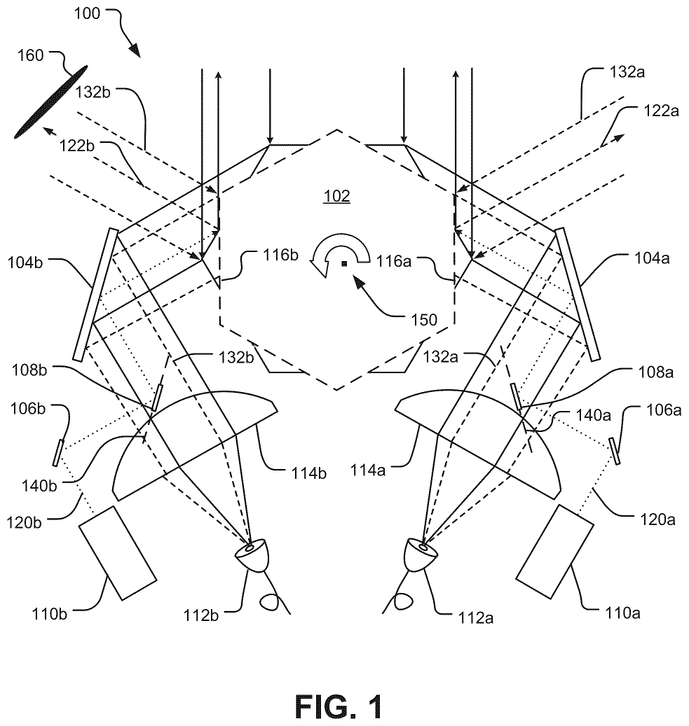

An example mechanically scanning LiDAR device 100, e.g., for automotive applications, is presented schematically in FIG. 1. The mechanically scanning LiDAR device 100 may include of two light sources, e.g., laser sources 110a, 110b, two optical detectors 112a, 112b, two collection lenses 114a, 114b, two vertical scanning mirrors 104a, 104b (also referred to as “galvo mirrors”), and one polygonal, rotating, horizontal scanning mirror 102 with n sides. In FIG. 1, component elements that are configured in substantial symmetry are indicated by “a” and “b” with respect to the corresponding reference numeral. When referring to such symmetric components together in the text, only the reference numeral may be used to refer to both of such symmetric components. Thus, for example, laser sources 110a and 110b may be referred to together as laser sources 110, detectors 112a and 112b may be referred to together as detectors 112, and so on.

In one implementation, each laser source 110 is directed into a respective vertical scan mirror 104 by auxiliary mirrors 106 and 108. The vertical scanning mirrors 104 direct the laser light (either continuous or pulsed) from the laser sources 110 to raster vertically (up and down) across a field of view (FoV) as the vertical scanning mirrors 104 articulate. The vertical scanning mirrors 104 are each mounted on horizontal pivot axes 140 resulting in laser light reflection at positive (upward) or negative (downward) angles from horizontal as the vertical scanning mirrors 104 pivot back and forth on the pivot axes 140. In one example implementation, the vertical scanning mirrors 104 oscillate about horizontal axes at 5 Hz per cycle about ±7.2° to provide a vertical scan range of about ±10° or 20° total.

In the embodiment of FIG. 1, the horizontal scanning mirror 102 may be hexagonally shaped and rotate on a vertical axis 150, orthogonal to the axes 140 of the vertical scanning mirrors 104. In alternative implementations, the horizontal scanning mirror 102 may be a 3-, 4-, 5-, or 7-sided polygonal mirror. The horizontal scanning mirror 102 rotates at a very high speed, e.g., hundreds of rotations per second. Each facet 116 of the hexagonal shape of the horizontal scanning mirror 102 successively sweeps the laser pulses from the laser sources 110 horizontally across the field of view as the horizontal scanning mirror 102 rotates. In an embodiment using a hexagonal-shaped horizontal scanning mirror 102, each facet 116 receives the laser light at angles of between 0° and 30° as each facet moves in and out of the laser beam. This translates into a horizontal sweep over the field of view of between 0° and 60° as the horizontal scanning mirror 102 rotates. The angle of reflection also changes as the horizontal scanning mirror 102 rotates, dependent on the angle of the facet 116 at any given instant. Thus, the horizontal scanning mirror 102 effectively scans the light beam 120 horizontally in the plane of the page of FIG. 1, while the vertical scanning mirrors 104 effectively scan the light beam 120 across the field of view vertically in and out of the plane of the page, resulting in a scan in two independent dimensions. Further, due to the configuration with two laser sources 110 and two vertical scanning mirrors 104 reflecting light to opposite facets 116 of the horizontal scanning mirror 102, the LiDAR device 100 effectively doubles the horizontal field of view to about 120°.

In FIG. 1, the light beam 120 reflected from the horizontal scanning mirror 102 is shown as outgoing beam 122. Objects 160 in the field of view which reflect light bounce scattered light back toward the LiDAR device 100. After colliding with an object 160, the back-scattered light beam 132 reflects off a facet of the horizontal scanning mirror 102 and is directed toward the vertical scanning mirrors 104 in reverse direction. The back-scattered light beam 132 reflects off the vertical scanning mirrors 104 toward the collection lenses 114. The collection lenses 114 focus the back-scattered light beam 132 toward the detectors 112. By relating the time of generation of light at the laser sources 110 to the time of receipt by the detectors 112, the mechanically scanning LiDAR device 100 can estimate the distance of the object in the field of view. Scanning thousands of laser pulses per second at different mirror positions, up and down and back and forth across the field of view, with the addition of range measurement, allows the LiDAR device 100 to map the field of view in the surrounding environment in three dimensions.

It should be understood that the actual implementation of the mechanically scanning LiDAR device 100 need not fit the precise geometric configuration as pictured in FIG. 1. In alternative implementations, the angles and component arrangements may be different than that disclosed in FIG. 1.

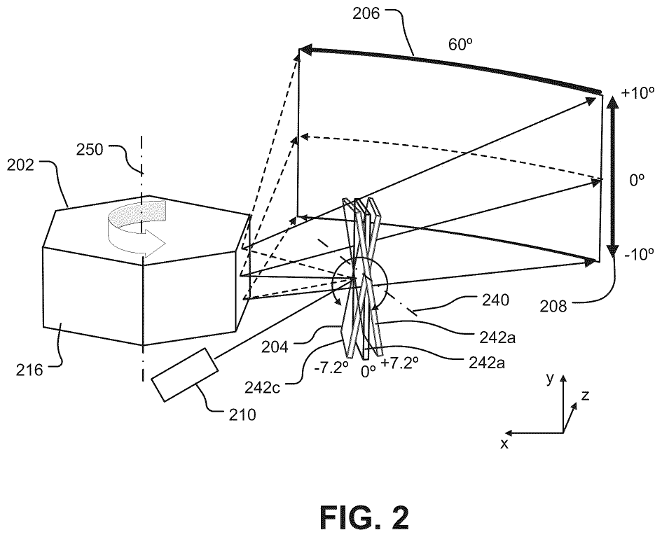

FIG. 2 schematically presents an isometric view of some of the components of a LiDAR device 200 to better depict the scan area and related field of view achieved. As in FIG. 1, the horizontal scan mirror 202 may be hexagonally shaped and rotate on a vertical axis 250. The vertical scan mirror 204 is mounted on a horizontal pivot axis 240 and moves between a vertical position 242a and a positive deflection angle 242b of 7.2° from vertical and a negative deflection angle 242c of −7.2° from vertical. As the vertical scan mirror 204 pivots back and forth on the pivot axis 240, laser light from the laser source 210 is reflected to the facets 216 of the horizontal scan mirror 202 at different heights between ±10° from a middle horizontal. The laser light then reflects off the facets 216 of the horizontal scan mirror 202 into the field of view. The horizontal scan mirror 202 thus provides a horizontal scan range of about 60° and the vertical scan mirror 204 similarly provides a vertical scan range 208 of about 20°.

As mentioned above, systems employing LiDAR sensor devices allow extraction of range information for objects in a field of view by detecting returning light emitted from a known laser source or sources at known times, positions, and orientations and measuring the round trip delay of the of the returning light. Intensity information of the returning light may also be used to determine range or surface features of objects in the field of view. In a mechanically scanning LiDAR device, such as the mechanically scanning LiDAR device 100 of FIG. 1, the rapidly spinning opto-mechanical scanner, e.g., the horizontal scanning mirror 102, introduces a scanner-induced angle offset to returning light.

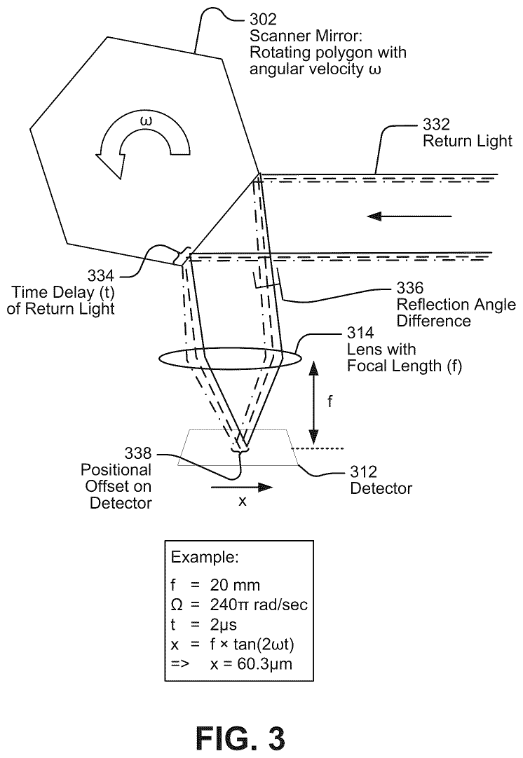

An example of this phenomenon is depicted in FIG. 3 in which the horizontal scan mirror 302 is a polygonal block shape with mirrored surfaces on each sidewall. The horizontal scan mirror 302 spins at an angular velocity ω. It is not feasible to stop or even slow down the horizontal scan mirror 302 while the emitted light pulse is in flight. The momentum of the horizontal scan mirror 302 ensures its motion will continue through a time delay period 334 (often a few microseconds) that an optical pulse is in flight. However, this means that the horizontal scan mirror 302 will be pointing in a slightly different direction when the returning light pulse 332 is received compared to when the light pulse was emitted. Because of this, the horizontal scan mirror 302 will reflect a returning light pulse 332 at a different angle compared to when it was transmitted. Often this reflection angle offset 336 is fractions of a degree, and it increases linearly with distance to the target that a light pulse reflects from. When the returning light pulse 332 is focused by a collection optic such as a lens 314, the lens 314 will focus the returning light pulse 332 onto a detector 312. However, the lens 314 also transforms the reflection angle offset 336 into a positional offset 338 on the detector face. This positional offset 338 becomes larger as the range to a target increases.

The magnitude of this positional offset 338 is usually a few 10's to potentially a few 100's of microns in typical embodiments. For example, as shown in the example of FIG. 3, for a lens 314 with focal length (f) of 20 mm, a rotational speed ω of the horizontal scan mirror 302, a total time delay period (t) 334 of the light pulse from targets in the field of view, the positional offset (x) 338 may be calculated by the equation x=f×tan(2 ωt). In this example, the positional offset (x) 338 is calculated to be 60.3 μm.

In coherent LiDAR systems, optical heterodyne detection is used to extract information from returning light encoded as modulation of the phase, frequency, or both, of the light emitted from the light source. For example, with frequency-modulated continuous wave (FMCW) LiDAR, light from the laser source is frequency shifted to emit linear optical frequency chirps. In another implementation, a pseudo-random binary sequence (PRBS) pattern may be encoded on the phase of the light emitted from the laser source. The returning light pulse is compared with a standard or reference light from a “local oscillator” signal directly from the light source that has a fixed offset in frequency and phase from the returning light pulse. Heterodyne mixing of the returning light pulse with the local oscillator signal light maps the target distance to a frequency or phase of the returning light signal. Coherent LiDAR provides both range and velocity measurements through the Doppler effect, providing highly-sensitive measurements with high dynamic range. Coherent LiDAR systems are often implemented using photonic integrated circuit (PIC) chips to manipulate the light pulses before transmission to achieve different desired transmission profiles. Advantageously, PIC chips for LiDAR are typically designed for operation around wavelengths of 1550 nm, which is beneficial in view of its resistance to sunlight glare and interference and conformance with eye-safety requirements for light sources in some applications, e.g., for automobiles. This wavelength also allows for more efficient range extension to 200 m or more, both because of the coherent encoding (yielding ˜10× signal-to-noise ratio gain) and, because of the greater eye safety at the wavelength, enough light generated to reach that range without requiring a very large collection aperture.

In a coherent LiDAR system, the optical elements are diffraction-limited, which requires highly precise alignment-on the order of a few microns or less-between the transmitter of the light from the light source and the detector. This corresponds to alignment tolerances 0.1 to 0.05 degrees with respect to reflecting transmitted or received light off the rotating scanning mirror. This alignment process can represent a bottleneck in the manufacturing process because it requires active feedback to align multiple elements, rather than simply setting the parts into place. Elimination of the need for active alignment between the transmitter and the detector, or a reduction in the number of elements that need to be actively aligned, would be an improvement to the manufacturing process for coherent LiDAR devices.

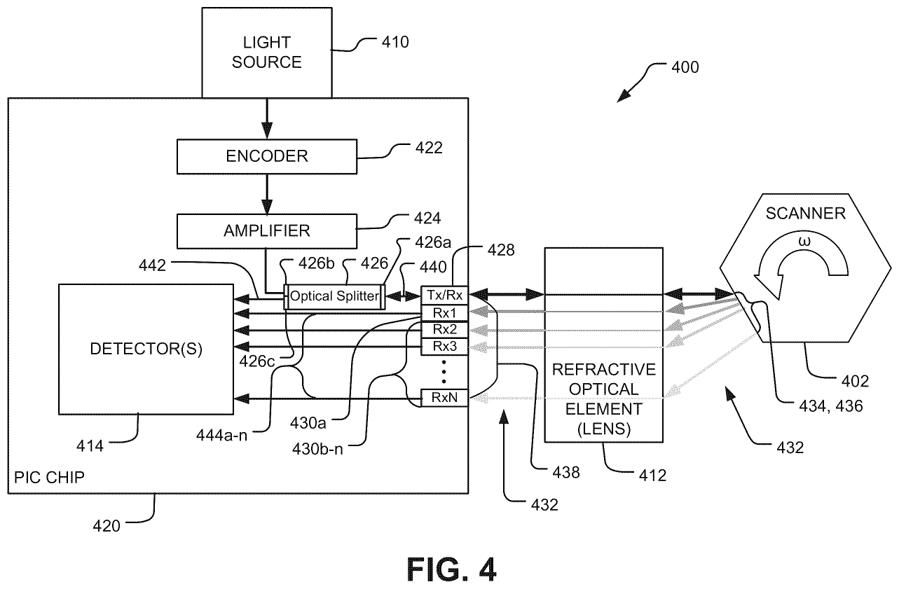

An example embodiment of a LiDAR system 400 is depicted in FIG. 4. Major components of the LiDAR system 400, similar to the system of FIG. 1 include a light source 410 (e.g., a laser configured to generate light pulses), a rotating scanning mirror 402 (e.g., a polygonal-shaped block with mirrored edges fixed to the shaft of an electric motor), a lens 412 (e.g., a collimator or other refractive optical element), and a detector 414 (e.g., a photodiode, an array of photodiodes, or a silicon avalanche photodiode (APD)). In this embodiment, the detector 414 may be part of an application-specific integrated circuit (ASIC) mounted on or otherwise fabricated on a portion of a PIC chip 420. Several other components may also be fabricated on the PIC chip 420 as further described below. Further, the detector 414 may comprise an array of multiple detectors, for example, arranged in parallel, or a single detector unit with an integrated array of detector cells. In addition to the detector 414, an encoder 422 (e.g., to introduce frequency or phase modulation to the light signal) and an optical amplifier 424 may likewise be fabricated on the PIC chip 420, e.g., by lithographic or other fabrication techniques. In some embodiments, the encoder 422 may be part of an ASIC mounted on the PIC chip 420.

A first free space coupler 428 may be lithographically fabricated on an edge of the PIC chip 420. A second free space coupler 430a may also be lithographically fabricated on the edge of the PIC chip 420 spaced slightly apart from and lithographically aligned with the first free space coupler 428. Through lithographic alignment on the PIC chip 420, the fine tolerances of sub-micrometer spacing to account for positional offset 438 on the detector 414, corresponding to the small angular offset 436 of returning light 432 directed to the detector 414 from the rotating scanning mirror 402 due to the time delay 434 of returning light 432 reflecting off targets at different ranges, can be achieved. The spacing distance between the first free space coupler 428 and the second free space coupler 430a may be calculated according to the formula of FIG. 3, i.e., based upon the extent of positional offset 438 of the returning light 432 resulting from angular lag corresponding to rotation of the rotating scanning mirror 402. Recall from the Illustration in FIG. 3 that returning light 432 from a light pulse moves laterally across the detector 414. Depending on the exact time delay 434 that the light experiences in transit, the focal spot on the detector 414 will be at a different position due to the slight angle offset 436 induced by the rotating scanning mirror 402. As noted above with respect to FIG. 3, the positional offset 438 for various increments of time delay 434 (which effectively corresponds to the range to target reflecting the incident light pulse) reflecting off the rotating scanning mirror 402 can be calculated using the time delay 434, the rotational speed of the rotating scanning mirror 402, and the effective focal length of the lens 412.

A transmission waveguide 440 is lithographically fabricated on the PIC chip 420 and is optically coupled at a first end to the light source 410, either directly, or indirectly with one or more intervening components or structures as further described below. A receiver waveguide 444a is also lithographically fabricated in the PIC chip 420 and extends between and is optically coupled at a first end to the second free space coupler 430a and optically coupled at a second end to the detector 414.

In some exemplary embodiments, an optical signal router, such as an optical splitter 426 or an optical circulator, may also be fabricated on the PIC chip 420. In the embodiment depicted in FIG. 4, the optical signal router is a 2×1 optical splitter 426 oriented in a reverse configuration. A typical 2×1 optical splitter has a single input and splits the light signal passing through it into two output channels. The percentage of light split between the two output channels may be congruent or different depending upon the design of the optical splitter 426. As noted, in the embodiment shown in FIG. 4, the orientation of the optical splitter 426 is reversed from that of typical implementations. In this implementation, the input port 426a of the optical splitter 426 is optically coupled with the transmission waveguide 440 and thereby to the first free space coupler 428. A first output port 426b of the optical splitter 426 is optically coupled via a waveguide to the light source 410, either directly or with intervening components such as the amplifier 424 and encoder 422. A second output port 426c of the optical splitter 426 is optically coupled to the detector 414 via an output receiver waveguide 442 lithographically fabricated within the PIC chip 420.

Currently there are no acceptable solutions, e.g., devices such as an optical isolator or circulator, available for PIC chips, which would allow transmission of 100% of the light from the light source 410 and then direct 100% of the received returning light 432 to the detector 414. However, if an optical splitter with 50:50 transmission in both transmit and receive directions were used, the output light will only transmit with a 50% efficiency, meaning the overall LiDAR performs half as well as it otherwise could because of the low intensity of the transmitted light. Instead, by using a highly skewed optical splitter 426, e.g., with between 95:5 and 99:1 transmission in both transmit and receive directions, between 95%-99% efficiency in transmission is achieved, so the LiDAR overall performs almost identical to an idealized circulator.

In this configuration, light pulses from the light source 410, after passing through the encoder 422 and the optical amplifier 424, if present, are thus received via a waveguide at the first output port 426b of the optical splitter 426. The optical splitter 426 is a passive element and the light pulses are free to travel through it in any direction. Thus, almost all of the light in the light pulses generated by the light source 410 will exit the optical splitter 426 through the input port 426a and travel over the transmission waveguide 440 to the first free space coupler 428 where they exit the PIC chip 420 and travel to the lens 412 and the rotating scanning mirror 402 before exiting the LiDAR system 400. Photons of the light pulses reflecting off of extremely close targets in the field of view will return extremely quickly such that there is very little angular offset 436 caused by the rotating scanning mirror 402. That portion of the returning light 432 thus returns through the lens 412 with almost no positional offset 438 and is aligned with the first free space coupler 428.

In such a situation, the first free space coupler 428 may operate as an optical transceiver (i.e., as both a transmitter and a receiver) and additionally receive a portion of the returning light 432 from the rotating scanning mirror 402. This portion of the returning light 432 travels through the optical splitter 426 in the normal direction such that some of the returning light exits the optical splitter 426 through the first output port 426b and returns to the light source 410 and the remainder exits the optical splitter 426 through the second output port 426c and as ultimately received at the detector 414 via the output receiver waveguide 442. As noted above, depending upon chosen design only 1%-5% of the returning light 432 through the first free space coupler 428 will pass through the optical splitter 426 to reach the detector 414. Understanding, however, that the intensity of the returning light 432 decreases at the inverse of travel distance (double the range (R)) squared (i.e., 1/(2R)²), the intensity of returning light 432 reflected from a short distance (e.g., <15 m) most likely to hit the first free space coupler 428 will be 400 times as strong as returning light 432 from a 300 m target (per the relationship I₂/I₁=(2R₁)²/(2R₂)²).

The LiDAR system 400 is typically designed to be sensitive to light that travels 400 m-600 m round trip. Thus, the detector 414 is sensitive to light intensity at 0.25% of the intensity collected at the first free space coupler 428. When further considering that the optical splitter 426 in line with the first free space coupler 428 will diminish the intensity of the returning light 432 along that path to 1%-5% of the intensity received at the first free space coupler 426, the intensity at the detector 414 is still 4 times the intensity of light returning from a 300 m target, which is plenty for rendering images. Thus, use of the optical splitter 426 in a reverse orientation may come at the cost of lower signal strength from nearby targets due to the beam split of the returning light 432 and being less coherent due to interference with outgoing light pulses. However, the returning light 432 from nearby targets is much less attenuated than returning light 432 from targets near the maximum range, resulting in a net gain in the overall range that can be detected, as long as the decoherence is not overwhelmingly strong.

A plurality of additional free space couplers 430b-n (Rx2-RxN) may also be lithographically fabricated on the PIC chip 420 and optically coupled to a plurality of corresponding detectors 414 (or respective inputs among an array of inputs formed on a single, integrated detector) by a corresponding plurality of additional receiver waveguides 444b-n. As with the second free space coupler 430a, the spacing distance between the first free space coupler 428 and the additional free space couplers 430b-n may be calculated according to the formula of FIG. 3, i.e., based upon the extent of positional offset 438 of the returning light 432 resulting from angular offset 436 corresponding to rotation of the rotating scanning mirror 402. As before, the positional offsets 438 for various increments of time delay 434 reflecting off the rotating scanning mirror 402 can be calculated using the time delay 434, the rotational speed of the rotating scanning mirror 402, and the effective focal length of the lens 412.

The PIC chip 420 is positioned and oriented within the LiDAR system 400 such that the free space couplers 428, 430a-n are located across from the lens 412 (or an intermediate mirror reflecting light from or to the lens 412) to transmit pulsed light to or receive focused or collimated returning light 432 that passes through the lens 412. Through lithographic alignment on the PIC chip 420, the additional free space couplers 430b-n may be positioned to coincide with the sub-micrometer positional offset 438 of the returning light 432 resulting from the combination of time-of-flight delay and the angular velocity of the rotating scanning mirror 402. Fabrication of the detector 414 on the PIC chip 420 allows for easy alignment of multiple sensors along the detector 414 corresponding to each of the additional free space couplers 430b-n as compared to tedious mechanical alignment multiple detectors with the lens and related testing to ensure registration and capture of returning light across the length of the positional offset to ensure capture of all targets at different ranges within the field of view.

With this understanding of the structure and components of the LiDAR system 400 incorporating the self-aligned PIC chip 420 for light detection, the path of a light pulse from the light source 410 can now be easily understood. Light pulses are coupled into a waveguide on the PIC chip 420 either from an internal (i.e., fabricated on the PIC chip 420) or external light source 410 and sent through the first output port 426b of the optical splitter 426. The light pulse then travels through the input port 426a along the transmission waveguide 440 to the first free space coupler 428. The light pulse leaves the PIC chip 420 from the first free space coupler 428 and passes through a refractive optical element, i.e., the lens 412, which collimates the light pulse into a beam. This collimated light pulse is then routed to the rotating scanning mirror 402, which transmits the light into the field of view.

When the light returns to the LiDAR system after reflecting off of targets within the field of view, the different travel times of portions of the returning light 432 (i.e., delay due to different ranges to targets) cause the rotating scanning mirror 402 to induce a lag or offset angles 436 on the different portions of the returning light 432. The lens 412 collimates and translates the portions of the returning light 432 into different positional offsets 438 along the edge of the PIC chip 420. The array of free space couplers 428, 430a-n function as receivers (Rx1-RxN) for the returning light 432. As the second and additional free space couplers 430a-n are lithographically aligned to the first free space coupler 428, they are able to receive the returning light 432 with high efficiency. The returning light 432 collected at each of these receive-only second and additional free space couplers 430b-n) is routed to one or more detectors 414 either on or off the PIC chip 420.

For very close targets, the lag angle may not be enough to reach the receiver-only second and additional free space couplers 430a-n. In this case, the first free space coupler 428 acts as a transceiver and collects this portion of the returning light 432 and passes it to the optical splitter 426. The optical splitter 426 routes some fraction of that light to the detector 414. Again, the efficiency is generally not a concern because nearby targets will produce much more reflected light than distant targets, so there is generally more than a sufficient amount of signal.

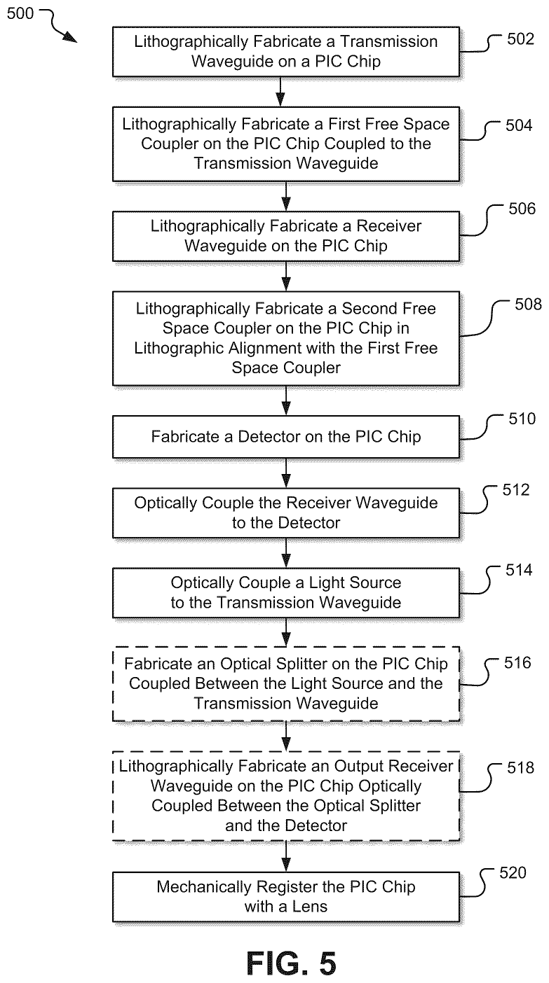

FIG. 5 is a flow diagram depicting an example method 500 of manufacturing an example implementation of a LiDAR system in which the light transmitter is aligned with one or more detectors. In a first fabrication step 502, a transmission waveguide is lithographically fabricated on a PIC chip. In a second fabrication step 504, a first free space coupler lithographically fabricated on the PIC chip at and optically coupled to a first end of the transmission waveguide. In a third fabrication step 506, a receiver waveguide is lithographically fabricated on the PIC chip. In a fourth fabrication step 508, a second free space coupler is lithographically fabricated on the PIC chip in lithographic alignment with the first free space coupler. In a fifth fabricating step 510, a detector is fabricated on or connected to the PIC chip. Then, in a first coupling step 512 at a first end of the receiver waveguide is optically coupled to the detector. In a second coupling operation 514, a light source that generates light pulses is optically coupled to the transmission waveguide.

In an optional sixth fabricating step 516, an optical splitter may be fabricated on the PIC chip and optically coupled between the light source and the transmission waveguide. In an optional seventh fabricating step 518, an output receiver waveguide may be fabricated on the PIC chip to optically couple the optical splitter and the detector. Then, in a registering step 520, the PIC chip is mechanically registered with a lens mounted within the LiDAR system. As a result of this method 500, the lens focuses both light pulses generated at the light source and output from the first free space coupler onto a rotating scanning mirror and returning light reflected from the scanning mirror onto the second free space coupler.

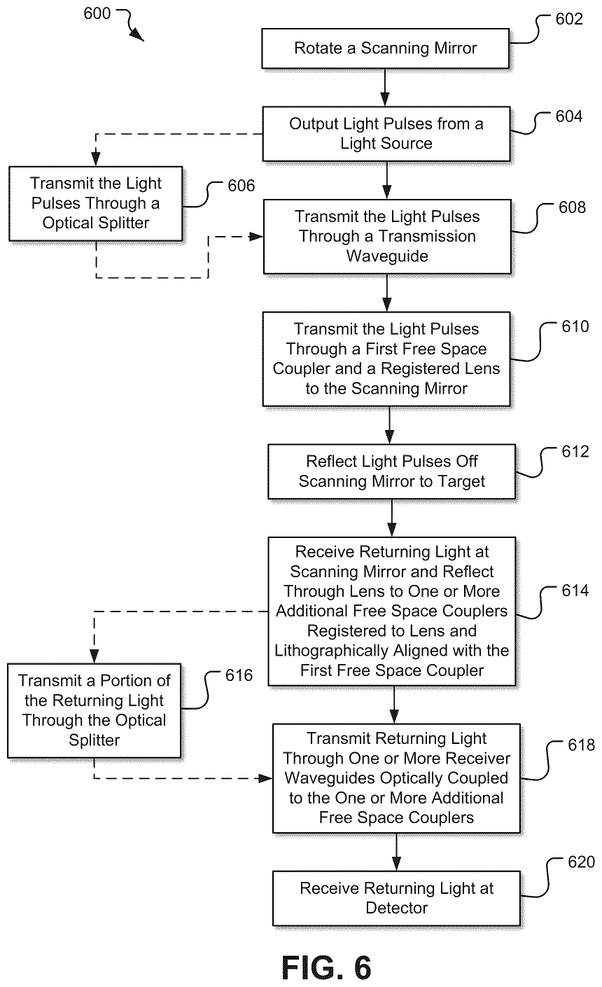

FIG. 6 is a flow diagram depicting an example method 600 of operating a LiDAR system, for example, the LiDAR system of FIG. 4. In a rotating operation 602, a scanning mirror is rotated at a very high angular velocity. In an outputting operation 604, light pulses are output from a light source. In an optional first transmitting operation 606, the light pulses may be transmitted through an optical splitter fabricated on a PIC chip. In a second transmitting operation 608, the light pulses may be transmitted through a transmission waveguide lithographically fabricated on PIC chip. The light pulses may reach the transmission waveguide with or without passing through the optical splitter. In a third transmitting operation 610, the light pulses may be transmitted from the transmission waveguide through a first free space coupler lithographically fabricated on the PIC chip, and further through a lens mechanically registered with the first free space coupler, to the rotating scanning mirror. In a reflecting operation 612, the light pulses are reflected off of the rotating scanning mirror toward a target at a distance from the LiDAR system,

Next, in a receiving operation 614, returning light from the target is received at the rotating scanning mirror and reflected through the lens to one or more free space couplers lithographically fabricated on the PIC chip and registered, wherein the lens is mechanically registered with the one or more additional free space couplers. The one or more additional free space couplers are further lithographically aligned with the first free space coupler on the PIC chip. In an optional fourth transmitting operation 616, the returning light may be transmitted through the optical splitter. In a fifth transmitting operation 618, the returning light through may be transmitted through one or receiver waveguides lithographically fabricated on the PIC chip and optically coupled to the one or more additional free space couplers. Finally, in a receiving operation 620, the returning light is received at a detector fabricated on the PIC chip and optically coupled to the one or more receiver waveguides.

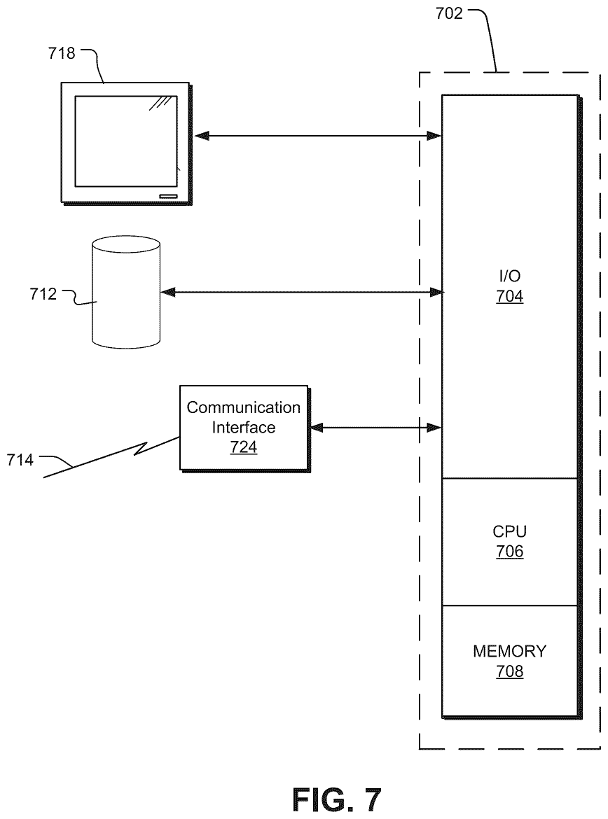

FIG. 7 illustrates an example computer processing system 700 that may be useful in implementing the described technology. The computer processing system 700 may be implemented in a device attached to the LiDAR device, such as a user device, storage device, internet of things (IoT) device, a desktop computer, a laptop computer, a processing system integrated into device or a vehicle in which the LiDAR is mounted, e.g., a security camera, an automobile, a drone, etc. The computer processing system 700 is capable of executing a computer program product embodied in a tangible computer-readable storage medium to execute a computer process. Data and program files may be input to the computer processing system 700, which reads the files and executes the programs therein using one or more processors 702 (e.g., central processing units, reduced instruction set computers (RISC)). Some of the elements of an example processing system 700 are shown in FIG. 7 wherein a processor 702 is shown having an input/output (I/O) section 704, a central processing unit (CPU) 706, and a local memory section 708.

The processor 702 of the computer processing system 700 may comprise a single central-processing unit 706 or a plurality of processing units. The processing unit(s) 706 may be single core or multi-core processors. The computer processing system 700 may be a conventional computer, a distributed computer, or any other type of computer. The described technology is optionally implemented in software loaded in local memory 708 (e.g., random access memory (RAM) or read only memory (ROM)), a memory hardware device 712 (e.g., a hard disk drive, an optical memory drive, Flash memory, etc.), and/or communicated via a wired or wireless network link 714 on a carrier signal (e.g., over Ethernet, a wireless local area network (LAN) protocols, Long Term Evolution (LTE) or 3/4/5G wireless, etc.) thereby transforming the computer processing system 700 in FIG. 7 into a special purpose machine for implementing the described operations.

The I/O interface 704 may be connected to one or more user-interface devices (e.g., a keyboard, a touch-screen display unit 718, etc.) or the memory hardware device 712. Computer program products containing mechanisms to effectuate the systems and methods in accordance with the described technology may reside in the local memory 708 or on the memory hardware device 712 of such a computer processing system 700.

A communication interface 724 is capable of connecting the computer processing system 700 to an enterprise network via the network link 714, through which the computer system can receive instructions and data embodied in a carrier wave. When used in a LAN environment, the computer processing system 700 may be connected by wired connection (e.g., Ethernet) or wirelessly (e.g., through a wireless access point or router using 902.11 protocols) to a local network through the communication interface 724. When used in a wide-area-network (WAN) environment, the computer processing system 700 typically includes a modem, a network adapter, or any other type of communications device for establishing communications over the WAN. In a networked environment, program modules depicted relative to the computer processing system 700 or portions thereof, may be stored in a remote memory storage device. It is appreciated that the network connections shown are examples of communications devices for and other means of establishing a communications link between computers may be used.

In an example implementation, a user interface software module, the communication interface 724, the input/output interface 704, and other modules may be implemented or embodied by instructions stored in memory 708 and/or the memory hardware device 712 and executed by the processor 702. Further, local computing systems, remote data sources and/or services, and other associated logic represent firmware, hardware, and/or software, which may be configured to assist in supporting a distributed ledger. In addition, keys, device information, identification, configurations, etc. may be stored in the memory 708 and/or the memory hardware device 712 and executed by the processor 702.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The embodiments of the invention described herein are implemented as logical steps in one or more computer systems. The logical operations of the present invention may be implemented (1) as a sequence of processor-implemented steps executing in one or more computer systems or (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

In an example implementation, a LiDAR system includes a light source configured to generate light pulses, a lens, a rotating scanning mirror, and a photonic integrated circuit (PIC) chip mechanically registered with the lens. The PIC chip further includes a transmission waveguide lithographically fabricated thereon, wherein a first end of the transmission waveguide is optically coupled to the light source. A first free space coupler is lithographically fabricated on the PIC chip and is positioned at a second end of and optically coupled to the transmission waveguide. A receiver waveguide is lithographically fabricated on the PIC chip. A second free space coupler is lithographically fabricated on the PIC chip and positioned at a first end of and optically coupled to the receiver waveguide. The second free space coupler is further lithographically aligned with the first free space coupler. A detector is fabricated on the PIC chip and optically coupled to a second end of the receiver waveguide. The lens focuses both light pulses generated at the light source and output from the first free space coupler onto the scanning mirror and returning light reflected from the scanning mirror onto the second free space coupler.

In an example of a related implementation, the LiDAR system further includes a configuration in which the first free space coupler functions as both a transmitter and a receiver, and the LiDAR system further comprises an output receiver waveguide lithographically fabricated on the PIC chip and optically coupled to the transmission waveguide at a first end and to the detector at a second end, wherein the lens is further configured to focus returning light reflected from the scanning mirror onto the first free space coupler.

In an example of a related implementation, the LiDAR system further includes an optical splitter fabricated on the PIC chip positioned between and optically coupled to each of the light source and the transmission waveguide and between the transmission waveguide and the output receiver waveguide to which it is also optically coupled.

In an example of a related implementation, the optical splitter is oriented such that light pulses from the light source are input to the optical splitter through a first output port of the optical splitter and transmitted to the first free space coupler through an input port of the optical splitter optically coupled to the transmission waveguide, and the returning light is received from the first free space coupler through transmission waveguide optically coupled to the input port and output from a second output port of the optical splitter optically coupled to the output receiver waveguide.

In an example of a related implementation, the LiDAR system further includes an encoder fabricated on the PIC chip positioned between the light source and the optical splitter.

In an example of a related implementation, the LiDAR system further includes an amplifier fabricated on the PIC chip positioned between the light source and the optical splitter.

In an example of a related implementation, the LiDAR system further includes an amplifier fabricated on the PIC chip positioned between the light source and the encoder.

In an example of a related implementation, the LiDAR system further includes a plurality of additional receiver waveguides lithographically fabricated on the PIC chip, and a plurality of additional free space couplers lithographically fabricated on the PIC chip at and optically coupled to respective first ends of the additional receiver waveguides, wherein each of the additional free space couplers is lithographically aligned with the first free space coupler and spaced apart from the first free space coupler at varying distances falling within a calculated extent of positional offset of the returning light resulting from angular lag corresponding to rotation of the scanning mirror. A plurality of additional detectors is fabricated on the PIC chip respectively corresponding to the additional receiver waveguides, wherein the additional detectors are optically coupled with respective second ends of the additional receiver waveguides. The PIC chip is mechanically registered with the lens such that the lens is configured to focus at least a portion of the returning light reflected from the scanning mirror onto one or more of the additional free space couplers.

In an example implementation, a method of aligning a transmitter with one or more receivers in a LiDAR system includes the following steps: lithographically fabricating a transmission waveguide on a photonic integrated circuit (PIC) chip; lithographically fabricating a first free space coupler on the PIC chip at a first end of and optically coupled to the transmission waveguide; optically coupling a light source that generates light pulses to a second end of the transmission waveguide; lithographically fabricating a receiver waveguide on the PIC chip; lithographically fabricating a second free space coupler on the PIC chip at a first end of and optically coupled to the receiver waveguide, and lithographically aligned with the first free space coupler; fabricating a detector on the PIC chip; optically coupling a second end of the receiver waveguide to the detector; and mechanically registering the PIC chip with a lens in the LiDAR system such that the lens focuses both light pulses generated at the light source and output from the first free space coupler onto a rotating scanning mirror and returning light reflected from the scanning mirror onto the second free space coupler.

In an example of a related implementation in which the first free space coupler functions as both a transmitter and a receiver, the method further includes lithographically fabricating an output receiver waveguide on the PIC chip optically coupled to the transmission waveguide at a first end and to the detector at a second end; and mechanically registering the PIC chip with the lens further configures the lens to focus returning light reflected from the scanning mirror onto the first free space coupler, wherein a portion of the transmission waveguide is configured to transmit returning light to the output receiver waveguide.

In an example of a related implementation, the method further includes fabricating an optical splitter on the PIC chip positioned between and optically coupled to each of the light source and the transmission waveguide and between the transmission waveguide and the output receiver waveguide to which it is also optically coupled

In an example of a related implementation, the method further includes orienting the optical splitter such that light pulses from the light source are input to the optical splitter through a first output port of the optical splitter and transmitted to the first free space coupler through an input port of the optical splitter optically coupled to the transmission waveguide, and the returning light is received from the first free space coupler through the transmission waveguide optically coupled to the input port and output from a second output port of the optical splitter optically coupled to the output receiver waveguide.

In an example of a related implementation, the method further includes fabricating an encoder on the PIC chip positioned between and optically coupled to the light source and the optical splitter.

In an example of a related implementation, the method further includes fabricating an amplifier on the PIC chip positioned between and optically coupled to the light source and the optical splitter.

In an example of a related implementation, the method further includes fabricating an amplifier on the PIC chip positioned between optically coupled to the light source and the encoder.

In an example of a related implementation, the method further includes lithographically fabricating a plurality of additional receiver waveguides on the PIC chip; lithographically fabricating a plurality of additional free space couplers on the PIC chip at and optically coupled to respective first ends of the additional receiver waveguides, wherein each of the additional free space couplers is lithographically aligned with the first free space coupler and spaced apart from the first free space coupler at varying distances falling within a calculated extent of positional offset of the returning light resulting from angular lag corresponding to rotation of the scanning mirror; fabricating a plurality of additional detectors on the PIC chip respectively corresponding to the additional receiver waveguides; and optically coupling the additional detectors with respective second ends of the additional receiver waveguides; and wherein mechanically registering the PIC chip with the lens in the LiDAR system further configures the lens to focus at least a portion of the returning light reflected from the scanning mirror onto one or more of the additional free space couplers.

In an example implementation, a method of operating a LiDAR system includes rotating a scanning mirror; outputting light pulses from a light source; transmitting the light pulses through a transmission waveguide lithographically fabricated on a photonic integrated circuit (PIC) chip; transmitting the light pulse through a first free space coupler lithographically fabricated on the PIC chip at a distal end of and optically coupled to the transmission waveguide through a lens mechanically registered with the first free space coupler to the scanning mirror; reflecting the light pulse off of the scanning mirror toward a target at a distance from the LiDAR system; receiving returning light from the target at the LiDAR system; reflecting the returning light from the scanning mirror through the lens to a second free space coupler lithographically fabricated on the PIC chip and lithographically aligned with the first free space coupler, wherein the lens is further mechanically registered with the second free space coupler; transmitting the returning light through a receiver waveguide lithographically fabricated on the PIC chip, wherein a distal end of the receiver waveguide is optically coupled to the second free space coupler; and receiving the returning light at a detector fabricated on the PIC chip and optically coupled to a proximal end of the receiver waveguide.

In an example of a related implementation, the method further includes reflecting the returning light from the scanning mirror through the lens to the first free space coupler; transmitting the returning light through the transmission waveguide to an output receiver waveguide lithographically fabricated on the PIC chip, wherein a distal end of the output receiver waveguide is optically coupled at a first end to the transmission waveguide and at a second end to the detector; and receiving the returning light at the detector through the output receiver waveguide.

In an example of a related implementation, the method further includes routing light pulses from the light source through an optical splitter fabricated on the PIC chip and positioned between and optically coupled to each of the light source and the transmission waveguide and also positioned between the transmission waveguide and the output receiver waveguide to which it is also optically coupled.

In an example of a related implementation, the method further includes routing light pulses from the light source for input to the optical splitter through a first output port of the optical splitter; transmitting the light pulses through the transmission waveguide to the first free space coupler through an input port of the optical splitter optically coupled with the transmission waveguide; receiving the returning light from the first free space coupler through the transmission waveguide optically coupled to the input port; and outputting the returning light from a second output port of the optical splitter optically coupled to the output receiver waveguide.

In an example of a related implementation, the method further includes reflecting the returning light from the scanning mirror through the lens to a plurality of additional free space couplers lithographically fabricated on the PIC chip, wherein the additional free space couplers are lithographically aligned with and spaced apart from the first free space coupler at varying distances falling within a calculated extent of positional offset of the returning light resulting from angular lag corresponding to rotation of the scanning mirror and the lens is further mechanically registered with the additional free space couplers to focus at least a portion of the returning light reflected from the scanning mirror onto one or more of the additional free space couplers; transmitting the returning light through a plurality of additional receiver waveguides lithographically fabricated on the PIC chip and optically coupled to respective ones of the additional free space couplers; and receiving the returning light at a plurality of additional detectors fabricated on the PIC chip respectively corresponding to and optically coupled to the additional receiver waveguides.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only, and the dimensions, positions, order, and relative sizes reflected in the drawings attached hereto may vary.

Implementations of technology disclosed herein includes a method of operating a LiDAR system wherein the method includes rotating a scanning mirror, outputting light pulses from a light source, transmitting the light pulses through a transmission waveguide lithographically fabricated on a photonic integrated circuit (PIC) chip, transmitting the light pulse through a first free space coupler lithographically fabricated on the PIC chip at a distal end of and optically coupled to the transmission waveguide through a lens mechanically registered with the first free space coupler to the scanning mirror, reflecting the light pulse off of the scanning mirror toward a target at a distance from the LiDAR system, receiving returning light from the target at the LiDAR system, reflecting the returning light from the scanning mirror through the lens to a second free space coupler lithographically fabricated on the PIC chip and lithographically aligned with the first free space coupler, wherein the lens is further mechanically registered with the second free space coupler, transmitting the returning light through a receiver waveguide lithographically fabricated on the PIC chip, wherein a distal end of the receiver waveguide is optically coupled to the second free space coupler, and receiving the returning light at a detector fabricated on the PIC chip and optically coupled to a proximal end of the receiver waveguide.

In one implementation, the method further includes reflecting the returning light from the scanning mirror through the lens to a plurality of additional free space couplers lithographically fabricated on the PIC chip, wherein the additional free space couplers are lithographically aligned with and spaced apart from the first free space coupler at varying distances falling within a calculated extent of positional offset of the returning light resulting from angular lag corresponding to rotation of the scanning mirror and the lens is further mechanically registered with the additional free space couplers to focus at least a portion of the returning light reflected from the scanning mirror onto one or more of the additional free space couplers; transmitting the returning light through a plurality of additional receiver waveguides lithographically fabricated on the PIC chip and optically coupled to respective ones of the additional free space couplers; and receiving the returning light at a plurality of additional detectors fabricated on the PIC chip respectively corresponding to and optically coupled to the additional receiver waveguides.

The above specification, examples, and data provide a thorough description of the structure and use of exemplary embodiments of the invention as defined in the claims. Although various embodiments of the claimed invention have been described above with a certain degree of particularity or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A LiDAR system comprising
a light source configured to generate light pulses;
a lens;
a rotating scanning mirror; and
a photonic integrated circuit (PIC) chip mechanically registered with the lens, the PIC chip further comprising
a transmission waveguide lithographically fabricated thereon, wherein a first end of the transmission waveguide is optically coupled to the light source;
a first free space coupler lithographically fabricated thereon and positioned at a second end of and optically coupled to the transmission waveguide;
a receiver waveguide lithographically fabricated thereon;
a second free space coupler lithographically fabricated thereon and positioned at a first end of and optically coupled to the receiver waveguide, and further lithographically aligned with the first free space coupler; and
a detector fabricated thereon and optically coupled to a second end of the receiver waveguide; wherein
the lens focuses both light pulses generated at the light source and output from the first free space coupler onto the scanning mirror and returning light reflected from the scanning mirror onto the second free space coupler.

2. The LiDAR system of claim 1, wherein in a configuration in which the first free space coupler functions as both a transmitter and a receiver, the LiDAR system further comprises
an output receiver waveguide lithographically fabricated on the PIC chip and optically coupled to the transmission waveguide at a first end and to the detector at a second end; wherein
the lens is further configured to focus returning light reflected from the scanning mirror onto the first free space coupler.

3. The LiDAR system of claim 2 further comprising an optical splitter fabricated on the PIC chip positioned between and optically coupled to each of the light source and the transmission waveguide and between the transmission waveguide and the output receiver waveguide to which it is also optically coupled.

4. The LiDAR system of claim 3, wherein the optical splitter is oriented such that light pulses from the light source are input to the optical splitter through a first output port of the optical splitter and transmitted to the first free space coupler through an input port of the optical splitter optically coupled to the transmission waveguide, and the returning light is received from the first free space coupler through transmission waveguide optically coupled to the input port and output from a second output port of the optical splitter optically coupled to the output receiver waveguide.

5. The LiDAR system of claim 3 further comprising an encoder fabricated on the PIC chip positioned between the light source and the optical splitter.

6. The LiDAR system of claim 3 further comprising an amplifier fabricated on the PIC chip positioned between the light source and the optical splitter.

7. The LiDAR system of claim 5 further comprising an amplifier fabricated on the PIC chip positioned between the light source and the encoder.

8. The LiDAR system of claim 1 further comprising
a plurality of additional receiver waveguides lithographically fabricated on the PIC chip;
a plurality of additional free space couplers lithographically fabricated on the PIC chip at and optically coupled to respective first ends of the additional receiver waveguides, wherein each of the additional free space couplers is lithographically aligned with the first free space coupler and spaced apart from the first free space coupler at varying distances falling within a calculated extent of positional offset of the returning light resulting from angular lag corresponding to rotation of the scanning mirror; and
a plurality of additional detectors fabricated on the PIC chip respectively corresponding to the additional receiver waveguides, wherein
the additional detectors are optically coupled with respective second ends of the additional receiver waveguides; and
the PIC chip is mechanically registered with the lens such that the lens is configured to focus at least a portion of the returning light reflected from the scanning mirror onto one or more of the additional free space couplers.

9. A method of aligning a transmitter with one or more receivers in a LiDAR system, the method comprising
lithographically fabricating a transmission waveguide on a photonic integrated circuit (PIC) chip;
lithographically fabricating a first free space coupler on the PIC chip at a first end of and optically coupled to the transmission waveguide;
optically coupling a light source that generates light pulses to a second end of the transmission waveguide;
lithographically fabricating a receiver waveguide on the PIC chip;
lithographically fabricating a second free space coupler on the PIC chip at a first end of and optically coupled to the receiver waveguide, and lithographically aligned with the first free space coupler;
fabricating a detector on the PIC chip;
optically coupling a second end of the receiver waveguide to the detector; and
mechanically registering the PIC chip with a lens in the LiDAR system such that the lens focuses both light pulses generated at the light source and output from the first free space coupler onto a rotating scanning mirror and returning light reflected from the scanning mirror onto the second free space coupler.

10. The method of claim 9, wherein, in a configuration in which the first free space coupler functions as both a transmitter and a receiver, the method further comprises
lithographically fabricating an output receiver waveguide on the PIC chip optically coupled to the transmission waveguide at a first end and to the detector at a second end; and
mechanically registering the PIC chip with the lens further configures the lens to focus returning light reflected from the scanning mirror onto the first free space coupler, wherein a portion of the transmission waveguide is configured to transmit returning light to the output receiver waveguide.

11. The method of claim 10 further comprising fabricating an optical splitter on the PIC chip positioned between and optically coupled to each of the light source and the transmission waveguide and between the transmission waveguide and the output receiver waveguide to which it is also optically coupled.

12. The method of claim 11 further comprising orienting the optical splitter such that light pulses from the light source are input to the optical splitter through a first output port of the optical splitter and transmitted to the first free space coupler through an input port of the optical splitter optically coupled to the transmission waveguide, and the returning light is received from the first free space coupler through the transmission waveguide optically coupled to the input port and output from a second output port of the optical splitter optically coupled to the output receiver waveguide.

13. The method of claim 11 further comprising fabricating an encoder on the PIC chip positioned between and optically coupled to the light source and the optical splitter.

14. The method of claim 11 further comprising fabricating an amplifier on the PIC chip positioned between and optically coupled to the light source and the optical splitter.

15. The method of claim 13 further comprising fabricating an amplifier on the PIC chip positioned between optically coupled to the light source and the encoder.

16. The method of claim 9 further comprising
lithographically fabricating a plurality of additional receiver waveguides on the PIC chip;
lithographically fabricating a plurality of additional free space couplers on the PIC chip at and optically coupled to respective first ends of the additional receiver waveguides, wherein each of the additional free space couplers is lithographically aligned with the first free space coupler and spaced apart from the first free space coupler at varying distances falling within a calculated extent of positional offset of the returning light resulting from angular lag corresponding to rotation of the scanning mirror;
fabricating a plurality of additional detectors on the PIC chip respectively corresponding to the additional receiver waveguides; and
optically coupling the additional detectors with respective second ends of the additional receiver waveguides; and wherein
mechanically registering the PIC chip with the lens in the LiDAR system further configures the lens to focus at least a portion of the returning light reflected from the scanning mirror onto one or more of the additional free space couplers.

17. A method of operating a LiDAR system comprising
rotating a scanning mirror;
outputting light pulses from a light source;
transmitting the light pulses through a transmission waveguide lithographically fabricated on a photonic integrated circuit (PIC) chip;
transmitting the light pulse through a first free space coupler lithographically fabricated on the PIC chip at a distal end of and optically coupled to the transmission waveguide through a lens mechanically registered with the first free space coupler to the scanning mirror;
reflecting the light pulse off of the scanning mirror toward a target at a distance from the LiDAR system;
receiving returning light from the target at the LiDAR system;
reflecting the returning light from the scanning mirror through the lens to a second free space coupler lithographically fabricated on the PIC chip and lithographically aligned with the first free space coupler, wherein the lens is further mechanically registered with the second free space coupler;
transmitting the returning light through a receiver waveguide lithographically fabricated on the PIC chip, wherein a distal end of the receiver waveguide is optically coupled to the second free space coupler; and
receiving the returning light at a detector fabricated on the PIC chip and optically coupled to a proximal end of the receiver waveguide.

18. The method of claim 17 further comprising
reflecting the returning light from the scanning mirror through the lens to the first free space coupler;
transmitting the returning light through the transmission waveguide to an output receiver waveguide lithographically fabricated on the PIC chip, wherein a distal end of the output receiver waveguide is optically coupled at a first end to the transmission waveguide and at a second end to the detector; and
receiving the returning light at the detector through the output receiver waveguide.

19. The method of claim 18 further comprising routing light pulses from the light source through an optical splitter fabricated on the PIC chip and positioned between and optically coupled to each of the light source and the transmission waveguide and also positioned between the transmission waveguide and the output receiver waveguide to which it is also optically coupled.

20. The method of claim 19 further comprising
routing light pulses from the light source for input to the optical splitter through a first output port of the optical splitter;
transmitting the light pulses through the transmission waveguide to the first free space coupler through an input port of the optical splitter optically coupled with the transmission waveguide;
receiving the returning light from the first free space coupler through the transmission waveguide optically coupled to the input port; and
outputting the returning light from a second output port of the optical splitter optically coupled to the output receiver waveguide.
